(19) United States
(12) Patent Application Publication
(10) Pub. No.: US 2009/0053386 A1
(43) Pub. Date: Feb. 26, 2009

(54) DELICIOUS SHRIMPS AND METHOD OF PRODUCING THE SAME

(75) Inventors: Masahito Matsukawa, Ibaraki (JP); Noriki Koyama, Ibaraki (JP); Masahiko Shimada, Ibaraki (JP); Masayuki Kanamori, Tokyo (JP); Jiro Yokota, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MARUHA CORPORATION, Chiyoda-ku (JP)

(21) Appl. No.: 11/914,026

(22) PCT Filed: May 1, 2006
(86) PCT No.: PCT/JP2006/309100

§ 371 Date: Nov. 9, 2007

(30) Foreign Application Priority Data
May 10, 2005 (JP) 2005 137768

(51) Int. Cl. A23L 1/33; A23L 1/00

(52) U.S. Cl. 426/643; 426/520; 426/665

(57) ABSTRACT

It is intended to provide a treatment method of producing fresh shrimp, either natural or farmed ones, having enriched taste which can be easily introduced into the course of processing while maintaining the freshness, and to provide processed shrimp products having enriched umami (delicious taste) over a broad scope including fresh products, frozen products, and cooked products.

Shrimp having enriched umami (delicious taste), in which the ratio of 5′-inosinic acid (IMP) in nucleic acid-relating substances is 40% or more; and a method of producing shrimp having enriched umami (delicious taste), in which the ratio of 5′-inosinic acid (IMP) in nucleic acid-relating substances is 40% or more, characterized by comprising maintaining the shrimp at a temperature of 10° C. to 50° C. for 0.1 to 24 hours.

### TECHNICAL FIELD

The present invention relates to shrimp having a higher IMP content and improved taste. Moreover, the present invention relates to a treatment method of enriching the umami (delicious taste) of fresh products or frozen products of shrimp.

### BACKGROUND ART

In Japan, shrimps in various types and forms, either natural or farmed ones, are imported and produced to be processed and consumed as prepared foods such as sushi, tempura, and fried shrimp. Japan has long been one of the largest consumers of shrimp in the world.

One of the reasons why shrimp is popular in Japan is that the unique taste and texture of shrimp suit the preferences of the Japanese (they prefer umami (delicious taste)).

The taste of shrimp comes from their components such as free amino acids represented by glycine, alanine, and glutamic acid, nucleic acid-relating substances including IMP and adenosine monophosphate (AMP), betaine, and organic acids, and shrimp that have a higher content of these components are regarded as tasty shrimp which are rich in the sweetness and umami (delicious taste) and are preferred.

Therefore, in the processing site, in order to increase the product value of shrimp, a method in which shrimp are immersed in a seasoning liquid (soaking liquid) blended with glycine, alanine, glutamic acid, and the like among free amino acids contained in shrimp, to increase the content of these components in the processing stage so as to improve the taste, has been practiced.

However, shrimp which have had taste added by this method have drawbacks in that the flavor is not quite the original flavor of shrimp and the taste is likely to be lost during cooking.

Meanwhile, there is an invention of shrimp having improved sweetness and umami (delicious taste) with a grater amount of free amino acids made by rearing farmed shrimp in rearing water having a higher salt concentration than that of previous rearing water for a fixed time, immediately after the shrimp are harvested from water (see Patent Document 1). The shrimp obtained by this method have a greater amount of free amino acids compared to conventionally farmed shrimp and the flavor is original flavor of shrimp.

However, in this invention, shells are removed due to the stress of high osmotic pressure in some cases, shrimp that can be a subject are limited to live shrimp being farmed, and furthermore this invention cannot be practiced unless a farming bed is equipped with a series of courses from farming to processing (generally a farming pond and a processing facility are separated from each other and thus the invention lacks versatility). Therefore, the invention is technically not a method that can be generally applied to food shrimp processing which have various production modes.

Next, regarding nucleic acid-relating substances which greatly influence the taste of fish separately from free amino acids, IMP in nucleic acid-relating substances, the accumulation of which is generally observed in fish, is already famous to have an effect of enriching umami (delicious taste) by its synergistic effect with glutamic acid (Glu) of a free amino acid. By leaving fish at a low temperature, adenosine triphosphate (ATP) in the living body rapidly decomposes into adenosine diphosphate (ADP)→AMPS→IMP posthumously, and is temporarily accumulated as IMP, thereby enriching the taste. However, if a long time has elapsed, or if fish have been left at a high temperature, its decomposition toward inosine (HxR) and hypoxanthine (Hx) progresses, reducing the freshness and raising the K value serving as an index of the freshness.

Incidentally, if shrimp is left at a low temperature, both AMP and IMP are accumulated, and the state as observed in fish where IMP alone is rich does not occur. AMP that is temporarily accumulated in shrimp also has a synergistic effect of umami (delicious taste) with Glu. However, this effect greatly differs from that of IMP, and the synergistic effect of AMP is known to stop at 18% where the effect of IMP is 100% (see Non Patent Document 1).

According to the results of the investigation and report on the pattern of posthumous changes in nucleic acid components of kuruma shrimp (see Non Patent Document 2), the IMP accumulation ratios (%) at respective temperatures in maximum storage times are: 42% for 144 hours (6 days) storage at −3° C.; 43% for 144 hours (6 days) storage at 0° C.; 36% for 48 hours (2 days) storage at 5° C.; and 33% for 24 hours (1 day) storage at 10° C., and it has been understood that IMP is not accumulated at low temperatures of 10° C. or less without taking a very long time. However, in actual production, if storage takes such a long time, a problem of black discoloration that is peculiar to shrimp occurs, and also the K value serving as an index of the freshness is thought to exceed 20%, causing a concern of losing the product value, and a concern of microbial issues in situations of actual production.

Further, the case of kuruma shrimp has already been reported on the above document. However, regarding two types of currently commercially important shrimps, black tiger shrimp and vannamei shrimp, there was no publicly known information related to posthumous changes in nucleic acid components by reference documents and the like, at all.

Patent Document 1: JP Patent Publication (Kokai) No. 07-170886 A (1995)

Non Patent Document 1: SHINGO IKEDA and TSUNEHIKO NINOMIYA, JOURNAL OF FOOD SCIENCE-VOLUME 36 (1971)

Non Patent Document 2: Misuzu Matsumoto, Hideaki Yamanaka, “Studies of Rigor Mortis of Kuruma Prawn”, Nippon Suisan Gakkaishi, 57 (11):2121-2126 (1991).

### DISCLOSURE OF THE INVENTION

It is an objective of the present invention to provide a treatment method of producing fresh shrimp, either natural or farmed ones, having enriched taste which can be easily introduced into the course of processing while maintaining the freshness, and to provide processed shrimp products having enriched umami (delicious taste) over a broad scope including fresh products, frozen products, and cooked products.

First, the inventors of the present invention focused on the fact that the taste differs even among the same type of shrimp, and investigated the relationship between the taste components and the taste of shrimp. As a result, they discovered that the difference in the composition ratio of nucleic acid-relating substances influences the taste, in particular the umami (delicious taste), rather than the amounts of individual free amino acids that signify the taste and the total amount of free amino acids. Specifically, they discovered that in a case of frozen/fresh shrimp, the total amount of nucleic acid-relating substances was 8 to 12 μmol/g, the majority of which (>80%) were AMP and IMP, however shrimp that were deemed to be rich in the sweetness/umami (delicious taste) in the sensory evaluation have a tendency to contain greater amount of IMP than AMP.

Therefore, they have intensively studied on a treatment method of producing an IMP rich state using shrimp in a state where the contents of ATP, ADP, AMP and IMP were high, that is, a state where the K value was 20% or less. As a result, the present invention was completed which obtains shrimp having a significantly increased IMP while having only a small rise of the K value (an small accumulation of HxR/Hx) by maintaining the shrimp within a fixed range of temperature zone for a fixed time. That is to say, a method of accumulating a high concentration of IMP in the body of shrimp by suppressing an IMP→HxR reaction while promoting an AMP→IMP reaction, has been invented.

They found out that shrimp having IMP increased by this invention were significantly richer in the umami (delicious taste) compared to shrimp before having IMP increased, and became shrimp having an original flavor of shrimp and enriched umami (delicious taste) more easily than with conventionally performed methods to increase free amino acids.

That is, aspects of the present invention are as follows.
[1] A shrimp having enriched umami (delicious taste), in which a ratio of 5′-inosinic acid (IMP) in nucleic acid-relating substances is 40% or more.
[2] The shrimp according to [1], wherein a K value is 20% or less.
[3] The shrimp according to either one of [1] and [2], wherein an absolute concentration of IMP is 3 μmol/g or more.
[4] A fresh product, a frozen product, or a cooked product that uses the shrimp according to any one of [1] to [3].

[5] The shrimp according to any one of [1] to [4], wherein the shrimp belongs to the genus Penaeus.

[6] The shrimp according to [5], wherein the shrimp belonging to the genus Penaeus is any one of black tiger shrimp (Penaeus monodon), kuruma shrimp (Penaeus japonicus), fleshy shrimp (Penaeus chinensis), and vannamei shrimp (Penaeus vannamei).

[7] A method of producing a shrimp, wherein the shrimp according to any one of [1] to [4] is maintained at a temperature of 10° C. to 50° C. for 0.1 to 24 hours to thereby accumulate IMP in the body of the shrimp.

[8] The method of producing a shrimp according to [7], wherein the shrimp is maintained at a temperature of 15° C. to 40° C. for 0.1 to 10 hours to thereby accumulate IMP in the body of the shrimp.

[9] The method of producing a shrimp according to either one of [7] and [8], wherein a K value of the shrimp is suppressed to 20% or lower.

[10] A method of accumulating IMP in the body of a shrimp, wherein the shrimp is maintained at a temperature of 10° C. to 50° C. for 0.1 to 24 hours, in which an AMP→IMP reaction is promoted and an IMP→HxR reaction is suppressed in the reaction of nucleic acid-relating substances expressed by ATP→ADP→AMP→IMP→HxR→Hx that posthumously occurs in the body of the shrimp.

[11] The method according to [10], wherein the shrimp is maintained at a temperature of 15° C. to 40° C. for 0.1 to 10 hours.

[12] A shrimp produced by the method according to either one of [10] and [11].

According to the present invention, by maintaining various types of shrimps at a medium temperature of 15° C. to 40° C., a high concentration of IMP can be accumulated in a relatively short time and the umami (delicious taste) of the shrimp can be further enriched. Fundamentally, shrimp are different from fish in showing a property of hardly accumulating IMP, which requires a long time at low temperatures below 10° C., but conversely problems such as black discoloration occur at such low temperatures. Alternatively, treatment at high temperatures of 40° C. or more for an extremely short time also increases IMP, which however generates HxR and is conversely not efficient in terms of accumulating a high concentration of IMP. The present invention provides a method that enables to accumulate a high concentration of IMP by setting just an intermediate temperature to the storage temperature of posthumous shrimp, and provides shrimp that are rich in the umami (delicious taste) containing a high concentration of IMP.

This description includes part or all of the contents as disclosed in the description of Japanese Patent Application No. 2005-137768, which is a priority document of the present application.

### BRIEF DESCRIPTION OF THE DRAWINGS

FIG. 1-1 shows changes in the concentrations of AMP and IMP that occurred when frozen products of headless shell-on farmed black tiger shrimp were stored at 0° C.

FIG. 1-2 shows changes in the concentrations of AMP and IMP that occurred when frozen products of headless shell-on farmed black tiger shrimp were stored at 25° C.

FIG. 1-3 shows changes in the concentrations of AMP and IMP that occurred when frozen products of headless shell-on farmed black tiger shrimp were stored at 45° C.

FIG. 2 shows the relationship between IMP% and K values that occurred during the storage of frozen black tiger shrimp at various temperatures.

FIG. 3 shows the storage temperature dependence of K values when IMP accumulation was 40% in frozen black tiger shrimp.

FIG. 4-1 shows changes in the concentrations of AMP and IMP that occurred when frozen products of headless shell-on farmed vannamei shrimp were stored at 0° C.

FIG. 4-2 shows changes in the concentrations of AMP and IMP that occurred when frozen products of headless shell-on farmed vannamei shrimp were stored at 25° C.

FIG. 4-3 shows changes in the concentrations of AMP and IMP that occurred when frozen products of headless shell-on farmed vannamei shrimp were stored at 55° C.

FIG. 5 shows the relationship between IMP % and K values that occurred during the storage of frozen vannamei shrimp at various temperatures.

FIG. 6 shows the storage temperature dependence of K values when IMP accumulation was 40% in frozen vannamei shrimp.

FIG. 7-1 shows changes in the concentrations of AMP and IMP that occurred when frozen products of headless shell-on kuruma shrimp were stored at 10° C.

FIG. 7-2 shows changes in the concentrations of AMP and IMP that occurred when frozen products of headless shell-on kuruma shrimp were stored at 25° C.

FIG. 7-3 shows changes in the concentrations of AMP and IMP that occurred when frozen products of headless shell-on kuruma shrimp were stored at 45° C.

FIG. 8-1 shows changes in the concentrations of AMP and IMP that occurred when headless shell-on kuruma shrimp were stored at 10° C.

FIG. 8-2 shows changes in the concentrations of AMP and IMP that occurred when headless shell-on kuruma shrimp were stored at 20° C.

FIG. 9-1 shows changes in the concentrations of AMP and IMP that occurred when headless shell-on black tiger shrimp were stored at 7° C.

FIG. 9-2 shows changes in the concentrations of AMP and IMP that occurred when headless shell-on black tiger shrimp were stored at 20° C.

FIG. 10-1 shows changes in the concentrations of AMP and IMP that occurred when headless shell-on vannamei shrimp were stored at 7° C.

FIG. 10-2 shows changes in the concentrations of AMP and IMP that occurred when headless shell-on vannamei shrimp were stored at 20° C.

### BEST MODE FOR CARRYING OUT THE INVENTION

Shrimp serving as the raw material in the present invention is either farmed or natural edible shrimp that is not living, which may be any one of a fresh product and a frozen product, and may be in any form of headless/headed and shell-on/shell-off, although the headless form is preferable. The type of shrimp is not limited, but preferably shrimp belonging to the genus Penaeus, and more preferably black tiger shrimp (Penaeus monodon), kuruma shrimp (Penaeus japonicus), fleshy shrimp (Penaeus chinensis), or vannamei shrimp (Penaeus vannamei).

A shrimp product, which is defrosted frozen shrimp, fresh shrimp as it is, or killed live shrimp, is maintained at a temperature of 10 to 50° C., preferably 15 to 40° C. for 0.1 to 24 hours, preferably for 0.1 to 10 hours. The temperature is preferably 15° C. to 25° C. in a case of black tiger shrimp, and 15° C. to 40° C. in a case of vannamei shrimp. Examples of appropriate combinations of the temperature and time for storing shrimp include a combination of 25° C. and one hour, or two hours or more.

By maintaining the above temperature for the above time, IMP can be accumulated without accumulating AMP. That is to say, after the death of shrimp, nucleic acid-relating substances in the body of the shrimp mainly change as follows: ATP→ADP→AMP→IMP→HxR→Hx. Moreover, there is also a path on which the reaction advances AMP→adenosine→HxR, without passing through IMP in the middle of the above reaction path. According to the method of the present invention, since the AMP→IMP reaction is promoted in the body of shrimp while the IMP→HxR reaction is suppressed, the shrimp having a high IMP content and low HxR and Hx contents can be produced. In this case, the suppression of the IMP→HxR reaction refers to the AMP→IMP reaction advancing relatively preferentially to the IMP→HxR reaction in a series of the AMP→IMP→HxR reactions. Conversely, at temperatures of 10° C. or less, or 50° C. or more, since the IMP→HxR reaction occurs preferentially to the AMP→IMP reaction, the IMP content does not rise high.

At this time, for the purpose of preventing shrimp from drying, preferably the shrimp is put in a plastic bag or the like, to be deaerated and sealed. Alternatively, in order to bring the product temperature to a target temperature quickly, shrimp is immersed in a solution containing 3% to 20% sodium chloride adjusted to 30° C. to 40° C., until the temperature of the shrimp reaches the target temperature, then the solution is drained and the shrimp is left at a room temperature.

In this course, the amount of IMP serving as the umami (delicious taste) enriching component in nucleic acid-relating substances in shrimp increases preferentially, and reaches 40% or more of the total nucleic acid-relating substances, that is to say, of the nucleic acid components, which makes the shrimp having definite rich umami (delicious taste) together with the enrichment of umami (delicious taste) of glutamic acid contained in the shrimp. That is to say, shrimp of the present invention is shrimp in which the IMP amount in the total nucleic acid-relating substances is 40% or more, preferably 42% or more, and more preferably 45% or more. Here, the nucleic acid-relating substances include ATP, ADP, AMP, HxR (inosine), Hx (hypoxanthine), and IMP. The IMP amount in shrimp refers to the IMP amount in the muscle of the shrimp, which may be analyzed by, for example, using a section left remaining after the cephalothorax and abdomen are cut away while removing the back vein at the same time, consequently the shells covering the abdomen are removed, and further the first segment and sixth segment of the abdomen and the muscle section of the tail are removed, as an analysis section. In the present invention, the amount of nucleic acid-relating substances in shrimp refers to values analyzed in this way.

Moreover, the absolute amount of IMP in shrimp of the present invention is 3 μmol/g or more.

Moreover, this treatment hardly elutes components such as free amino acids in shrimp at all, and no change in the total amount of free amino acids can be seen.

Further, shrimp of the present invention is shrimp having a K value of 20 or less. Here, the K value refers to a value serving as an index of the freshness, and is expressed by: K value (%)=(HxR+Hx)/(ATP+ADP+AMP+IMP+HxR+Hx)×100. Generally, in a case where the K value is 20 or less, shrimp is suitable for raw consumption, and shrimp of the present invention can be consumed raw.

Further, examples of the composition of nucleic acid-relating substances in shrimp of the present invention include a composition in which the IMP amount is 40% to 60%, the AMP amount is 20% to 40%, and the HxR+Hx amount is 20% or less.

Shrimp of the present invention has a property of having enriched umami (delicious taste), and whether or not the umami (delicious taste) is enriched, can be determined by carrying out sensory tests such as a two-point discrimination testing method and a quantitative descriptive analysis method.

Shrimp processed in this way may be made into a frozen product by freezing either directly or after being cooked, and of course, may be directly cooked. In a case where shrimp obtained by the present invention is processed into sushi shrimp, the umami (delicious taste) of glutamic acid in soy sauce is enriched, resulting in sushi shrimp having further enriched umami (delicious taste). Moreover, even in a case where the shrimp is made into a processed product such as a tempura/fried shrimp, the processed product similarly has the enriched umami (delicious taste). Alternatively, even in a case where the shrimp is used as an ingredient of Chinese dish materials/soup or the like, the umami (delicious taste) of the whole cooked product is enriched. Therefore, this is a useful technique capable of extremely easily and sufficiently improving the taste.

### EXAMPLES

The present invention is hereafter described in greater detail with reference to the following examples, although the technical scope of the present invention is not limited thereto.

### Example 1

The analysis of nucleic acid components in shrimp was carried out by the following method. First, in a method of collecting an analysis sample from shrimp, the cephalothorax and abdomen were cut away while deveining at the same time, and consequently the shells covering the abdomen were removed. Further, the first segment and sixth segment of the abdomen and the muscle section of the tail were removed, and the section left remaining thereafter was sampled as the analysis section.

Next, in a method of extracting nucleic acid components, the collected shrimp were added with 20-fold weight of 5% trichloroacetic acid cooled in ice water, which were immediately homogenized into a suspension. The obtained suspension was centrifugally separated (at 3,000 rpm for 15 minutes (4° C.) with a domestically manufactured swing type centrifugal machine), and the liquid portion obtained as a supernatant was filter-processed (0.2 μm) to be prepared for the HPLC (high performance liquid chromatography) for nucleic acid analysis.

As to the contents of HPLC, the column used (temperature used) was GS-320HQ manufactured by Shodex Asahipak (30° C.), the eluent composition was a 200 mM phosphoric acid solution of pH 2.9, and the detection was carried out at a flow rate of 0.6 ml/min and a light absorption wavelength of 260 nm using an UV detection device. A Windows compatible software EZChrom Elite was used to calculate the quantitative values. The K value or IMP (%) was calculated according to the following equations from the quantitative values (μmol/g) of respective nucleic acid components.

K value (%)=(HxR+Hx)/(ATP+ADP+AMP+IMP+HxR+Hx)×100

IMP(%)=IMP/(ATP+ADP+AMP+IMP+HxR+Hx)×100

### Example 2

Table 1 shows analysis of free amino acids and nucleic acid components for the following cases: the case where frozen products of headless shell-on farmed black tiger shrimp (size 31/41 shrimp) that had been IQF frozen (individually quick frozen) were subjected to a defrosting treatment in running water at 20° C. for 20 minutes, which were drained then cooled on ice, and directly heated in boiling water for 3 minutes (unmatured lot); and the case where the drained shrimp were sealed in a plastic bag and stored in a constant temperature bath set at 20° C. for 2 hours, and then heated (matured lot).

TABLE 1

| | Unmatured lot | Matured lot |
|---|---|---|
| Free amino acid | | |
| (mg/100 g) | | |
| Tau | 25 | 27 |
| Asp | 23 | 5 |
| Thr | 66 | 136 |
| Ser | 16 | 26 |
| Glu | 76 | 79 |
| Gly | 615 | 616 |
| Ala | 311 | 224 |
| Cys | 15 | 19 |
| Val | 22 | 31 |
| Met | 7 | 9 |
| Ile | 6 | 9 |
| Leu | 16 | 21 |
| Tyr | 14 | 18 |
| Phe | 14 | 17 |
| Lys | 32 | 42 |
| His | 9 | 14 |
| Arg | 443 | 494 |
| Hypro | 0 | 0 |
| Pro | 272 | 345 |
| Total | 1984 | 2133 |
| Nucleic acid component | | |
| (μmol/g) | | |
| ATP | 0.0 | 0.1 |
| ADP | 0.9 | 0.8 |
| AMP | 5.7 | 3.2 |
| IMP | 2.9 | 6.7 |
| AdR | 0.2 | 0.1 |
| HxR | 0.7 | 0.8 |
| Hx | 0.2 | 0.4 |
| Total | 10.7 | 12.1 |
| K value | 8.7 | 9.6 |
| AMP % | 53.6 | 26.8 |
| IMP % | 27.0 | 55.4 |

As a result, there were no large differences observed in the concentration of total free amino acids, the concentration of total nucleic acids, and the K values. On the other hand, in the nucleic acid composition, AMP was 53.6% and IMP was 27% in the unmatured lot, while AMP was 26.8% and IMP was 55.4% in the matured lot. The ratio of AMP and IMP was reversed by storing at 20° C., and the accumulation of IMP was clearly observed.

### Example 3

On both of the test lots in the Example 2, sensory evaluation was carried out using a two-point discrimination testing method. The umami (delicious taste) was compared according to Table 2, resulting in that 20 people out of 26 people evaluated that the shrimp of the matured lot was richer in the umami (delicious taste). It was also confirmed statistically at a level of significance of 1% that the shrimp of the matured lot had definitely enriched umami (delicious taste).

TABLE 2
Sensory evaluation method of shrimp and its result

Date

Name:
Please evaluate the umami (delicious taste) of two boiled shrimps.
Please taste the sample on the left first.
Please circle the sample number with ◯ which was richer in the umami
(delicious taste).

| | |
|---|---|
| 154 | 213 |

Comment:

Thank you very much for your corporation.

<Sample> 154: Unmatured lot of Example 1, 213: Matured lot of Example 1

<Method> Two types of samples, 154 and 213, were given to select the richer sample in the umami (delicious taste) using the above sensory evaluation table.

<Panelist> Taste examiners: n=13 people

<Result> 213=10 people, 154=3 people

<Sample> 154: Matured lot of Example 1, 213: Unmatured lot of Example 1

<Method> Two types of samples, 154 and 213, were to select the richer sample in the umami (delicious taste) using the above table for sensory evaluation.

<Panelist> Taste examiners: n=13 people

<Result> 213=10 people, 154=3 people

<Test> Having a look at the column n=26 in the test table of the two-point discrimination testing method, there were respectively 18 people, 20 people, and 22 people of levels of significance of 5%, 1%, and 0.1% in this order, and the total number of people which answered that the matured lot was richer in the umami (delicious taste) becomes 20. Therefore, there is a difference between the unmatured lot and the matured lot at a level of significance of 1%, and the matured lot is judged as being definitely richer in the umami (delicious taste).

### Example 4

Table 3 shows analysis of free amino acids and nucleic acid components for the following cases: the case where frozen products of headless shell-on farmed vannamei shrimp (size 31/41 shrimp) that had been IQF frozen were subjected to a defrosting treatment in running water at 20° C. for 20 minutes, which were drained then cooled on ice, and directly heated in boiling water for 3 minutes (unmatured lot); and the case where the drained shrimp were added with 2-fold weight of 5% salt water adjusted to 30° C., which were left as they were for 2 hours, then drained again and heated (matured lot).

TABLE 3

| | Unmatured lot | Matured lot |
|---|---|---|
| Free amino acid | | |
| (mg/100 g) | | |
| Tau | 28 | 26 |
| Asp | 0 | 0 |
| Thr | 161 | 143 |
| Ser | 14 | 14 |
| Glu | 32 | 44 |
| Gly | 833 | 695 |
| Ala | 80 | 111 |
| Cys | 4 | 5 |
| Val | 30 | 32 |
| Met | 5 | 4 |
| Ile | 9 | 9 |
| Leu | 17 | 18 |
| Tyr | 13 | 13 |
| Phe | 12 | 13 |
| Lys | 20 | 22 |
| His | 18 | 17 |
| Arg | 644 | 570 |
| Hypro | 10 | 7 |
| Pro | 491 | 501 |
| Total | 2421 | 2242 |
| Nucleic acid component | | |
| (μmol/g) | | |
| ATP | 0.0 | 0.1 |
| ADP | 1.1 | 0.9 |
| AMP | 10.3 | 4.4 |
| IMP | 1.0 | 6.7 |
| AdR | 0.3 | 0.1 |
| HxR | 0.5 | 0.8 |
| Hx | 0.0 | 0.2 |
| Total | 13.3 | 13.2 |
| K value | 4.3 | 7.2 |
| AMP % | 77.4 | 33.6 |
| IMP % | 7.6 | 51.0 |

As a result, there were no large differences observed in the concentration of total free amino acids and the concentration of total nucleic acids. Moreover, an increase in the K value was observed in the matured lots, however, that value was 10% or less. On the other hand, in the nucleic acid composition, AMP was 77.4% and IMP was 7.6% in the unmatured lot, while AMP was 33.6% and IMP was 51% in the matured lot. Even in the case of vannamei shrimp, the ratio of AMP and IMP was reversed by storing at 20° C. and the accumulation of IMP was clearly observed.

### Example 5

On the boiled vannamei shrimp of both of the test lots in the Example 4, sensory evaluation was carried out using a quantitative descriptive analysis method (“Current status and perspectives of sensory evaluation techniques”, Tetsuo Aishima, A Technical Journal on Food Chemistry & Chemicals, Vol. 18, No. 1 (2002)) by 13 trained panelists. That is to say, special 13 panelists were gathered in one place and given the shrimp of both of the test lots, and then discussed what words they thought appropriate to evaluate the difference between both of these shrimp in terms of taste. As a result, it was confirmed that two items of sweetness and umami (delicious taste) were appropriate for shrimp, and were evaluating words that could be commonly recognized by everyone. Then, sensory evaluation was carried out again by individual panelists on these two items. The results are shown in Table 4, in which the shrimp of the matured lot were evaluated as definitely richer in both items of sweetness and umami (delicious taste). The results were subjected to a test on the difference in population means (by paired t-test). As a result, definite sensory differences were confirmed at a level of significance of 5% for the umami (delicious taste) and a level of significance of 1% for the sweetness.

TABLE 4
1) Evaluation of umami (delicious taste)

| Panelist | A | B | C | D | E | F | G | H | I | J | K | L | M |
|---|---|---|---|---|---|---|---|---|---|---|---|---|---|
| Matured | 81.5 | 56.5 | 66.7 | 76.5 | 53 | 53.5 | 61 | 41.5 | 25 | 49.5 | 35 | 100 | 36.5 |
| lot | | | | | | | | | | | | | |
| Unmatured | 19 | 37.5 | 24 | 87 | 52 | 26.5 | 49.5 | 29.5 | 25.5 | 17.5 | 36 | 41 | 49 |
| lot | | | | | | | | | | | | | |

Test result on difference in population means
Condition: two way
Formula: paired t-test

| | | | Difference |
|---|---|---|---|
| | Matured lot | Unmatured lot | (X1-X2) |
| Number of panelists | 13 | 13 | 0 |
| Mean value | 56.6 | 38.0 | 18.6 |
| Standard deviation | 20.8 | 18.7 | 2.1 |
| Number of samples | 13.0 | | |
| Mean value | 18.6 | | |
| Standard deviation | 24.8 | | |
| Amount of statistics | 2.7 | | |
| Degree of freedom | 12.0 | | |
| 0.5% point | 3.1 | | |
| 2.5% point | 2.2 | | |
| P value | 0.0 | | |
| Judgement mark | [*significant | | |
| | at the 5% level] | | |

2) Evaluation of sweetness

| Panelist | A | B | C | D | E | F | G | H | I | J | K | L | M |
|---|---|---|---|---|---|---|---|---|---|---|---|---|---|
| Matured | 75 | 66 | 61.3 | 84.5 | 53 | 61 | 62 | 50 | 19 | 68.5 | 40 | 100 | 55.5 |
| lot | | | | | | | | | | | | | |
| Unmatured | 17 | 37.5 | 32 | 87 | 60.5 | 41.5 | 59 | 23 | 17 | 35 | 24.5 | 50 | 58 |
| lot | | | | | | | | | | | | | |

Test result on difference in population means
Condition: Two way
Formula: paired t-test

| | | | Difference |
|---|---|---|---|
| | Matured lot | Unmatured lot | (X1-X2) |
| Number of panelist | 13 | 13 | 0 |
| Mean value | 61.2 | 41.7 | 19.5 |
| Standard deviation | 19.9 | 20.5 | −0.6 |
| Number of samples | 13.0 | | |
| Mean value | 19.5 | | |
| Standard deviation | 20.7 | | |
| Amount of statistics | 3.7 | | |
| Degree of freedom | 12.0 | | |
| 0.5% point | 3.1 | | |
| 2.5% point | 2.2 | | |
| P value | 0.0 | | |
| Judgement mark | [**significant | | |
| | at the 1% level] | | |

3) Sensory evaluation sheet used

| Date of sensory evaluation | |
|---|---|
| Name of sample 587 | Name |
| Evaluation method: | Please mark with a vertical line in a position that matches the evaluation of |
| | the sample, on the horizontal line. |
| Sweetness | 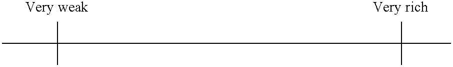 |
| Deliciousness | 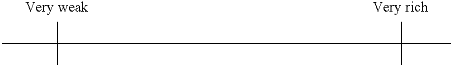 |

From the above results, it was proven that the umami (delicious taste) of shrimp has been definitely enriched sensorily by increasing the IMP amount in various nucleic acid components contained in shrimp.

### Example 6

Next, using frozen products of respective shrimp, the storage temperature at which IMP is efficiently accumulated was examined in detail.

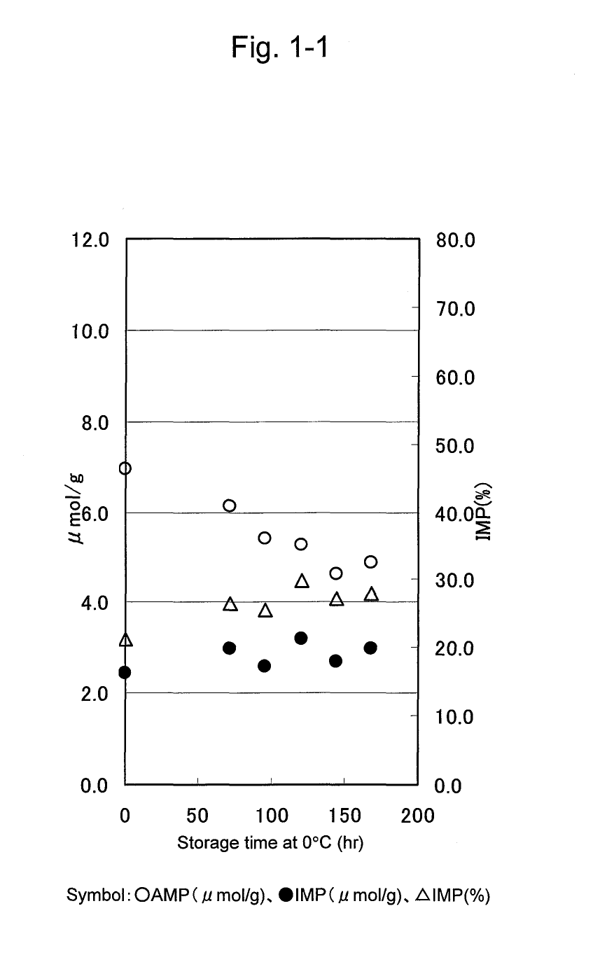

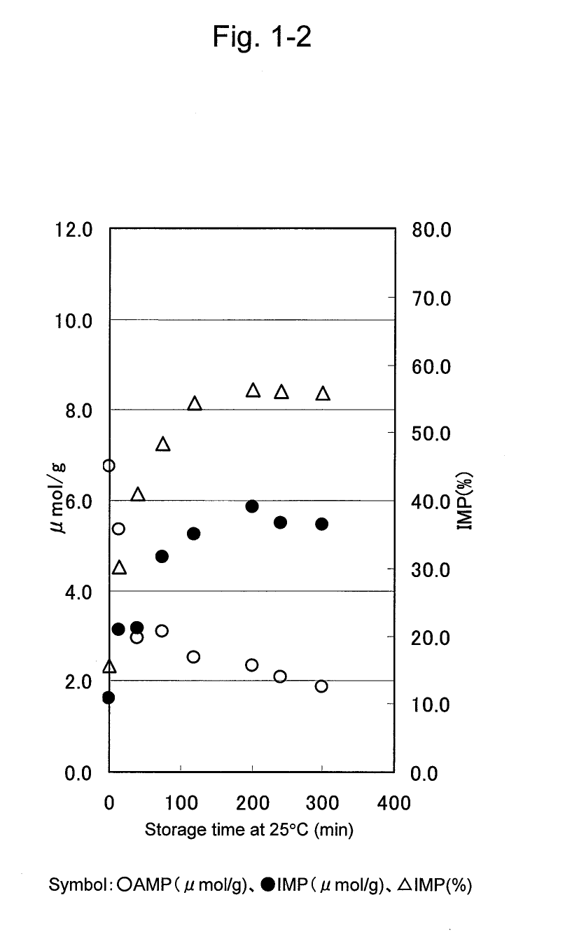

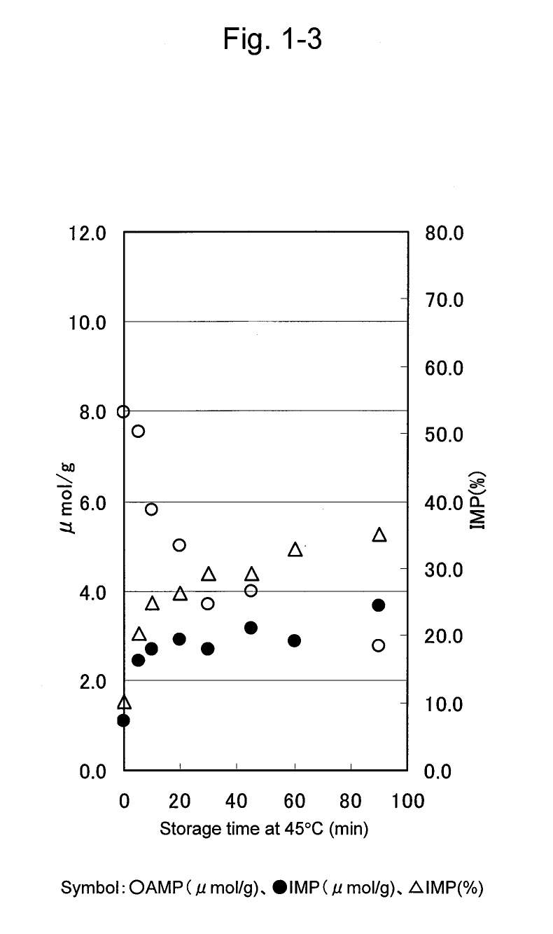

Frozen products of headless shell-on farmed black tiger shrimp (size 31/41 shrimp) that had been IQF frozen were subjected to a defrosting treatment in running water at 20° C. for 20 minutes, which were drained then cooled on ice, and stored for a predetermined time at 0° C., 25° C., and 45° C., to track the changes of nucleic acid components over time. The results are shown in FIG. 1-1 to FIG. 1-3. Although there were differences in speed due to the storage temperatures, AMP (◯) decreased over the storage time at any of the temperatures. On the other hand, IMP () and IMP % (Δ) increased merely slightly at 0° C. and 45° C., and IMP did not reach 40%. At 25° C., IMP increased over time and IMP (%) reached the maximum of 55%.

### Example 7

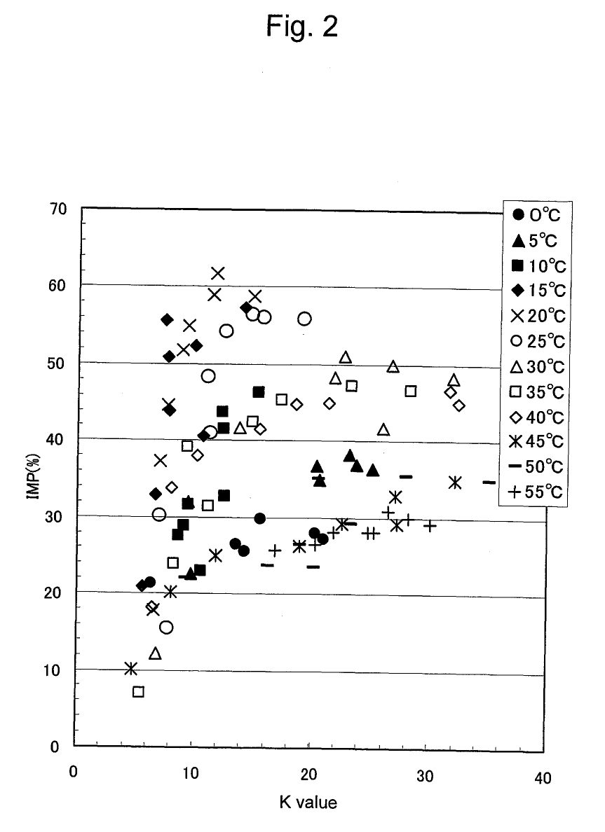

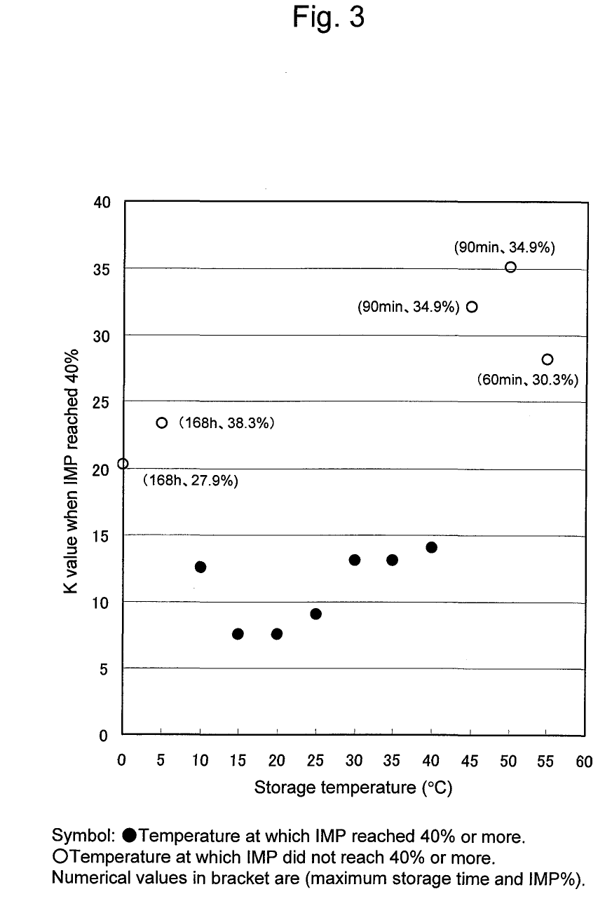

The data of Example 6 was added with data of storage at the temperatures of 5° C., 10° C., 15° C., 20° C., 30° C., 35° C., 40° C., 50° C., and 55° C., and the relationship between the increases in IMP (%) that occurred during the storage and the increases in the K value involved therein was shown in FIG. 2. In this result, at 15° C. to 25° C., the K value was within a range of 10% to 15% and IMP (%) hit the maximum of slightly under 60%. The maximum value of accumulating IMP (%) was lowered as the temperature moved away higher or lower from that storage temperature. Moreover, from the result of FIG. 2, the K value at the time point when IMP had reached 40% was read, and its relationship with the storage temperature was shown in FIG. 3, where the temperatures at which IMP did not reach 40% were shown with ◯, and the maximum storage time and the K value at that time point were noted inside the round brackets next to each symbol. According to this result, the temperatures at which IMP did not reach 40% were 0° C., 5° C., 45° C., 50° C., and 55° C. Within the temperature range of 10° C. to 40° C. where IMP (%) reached 40%, a U-letter shaped dependence with respect to temperature was shown. That is to say, in the case of black tiger shrimp, within the temperature range of 15° C. to 25° C., IMP reached 40% with a low K value (5% to 10%). However, when the temperature moved away higher or lower from that temperature range, the K value increased, and when the temperature deviated even further, the K value alone increased while IMP was not likely to increase for that amount.

### Example 8

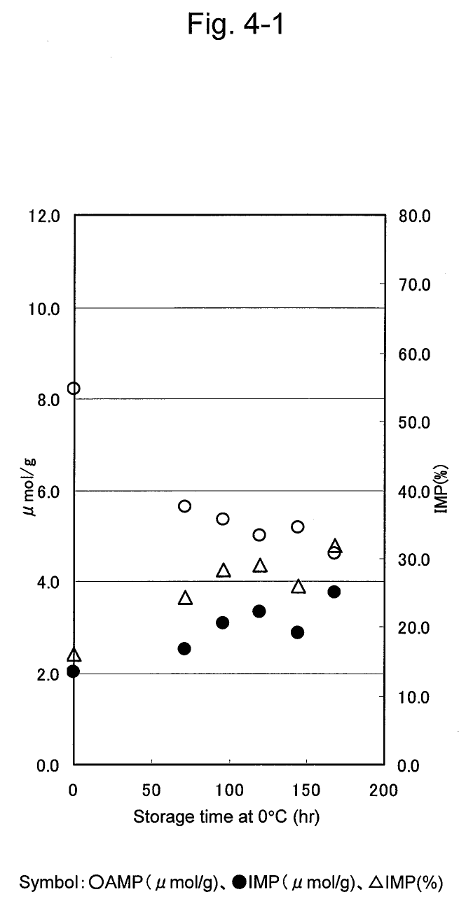

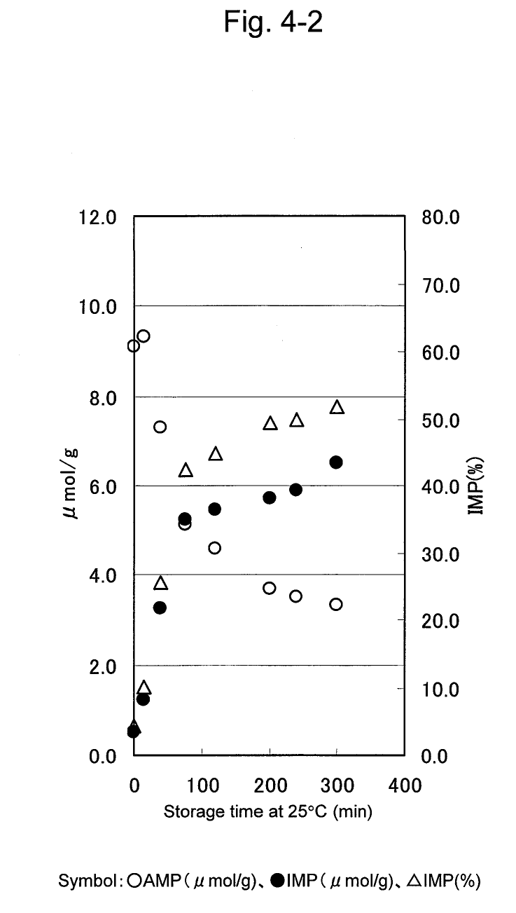

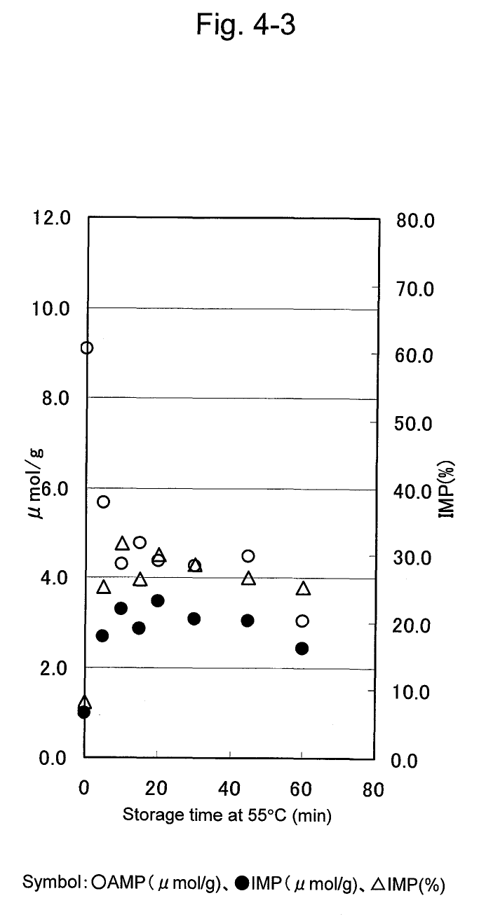

Frozen products of headless shell-on farmed vannamei shrimp (size 31/41 shrimp) that had been IQF frozen were subjected to a defrosting treatment in running water at 20° C. for 20 minutes, which were drained and then stored for a predetermined time at 0° C., 25° C., and 55° C., to track the changes of nucleic acid components over time. The results are shown in FIG. 4-1 to FIG. 4-3. Although there were differences in speed due to the storage temperature, AMP (◯) decreased over the storage time at any of the temperatures. On the other hand, IMP () and IMP% (Δ) increased merely slightly at 0° C. and 45° C., and IMP did not reach 40%. At 25° C., IMP increased over time and IMP (%) reached the maximum of slightly under 55%.

### Example 9

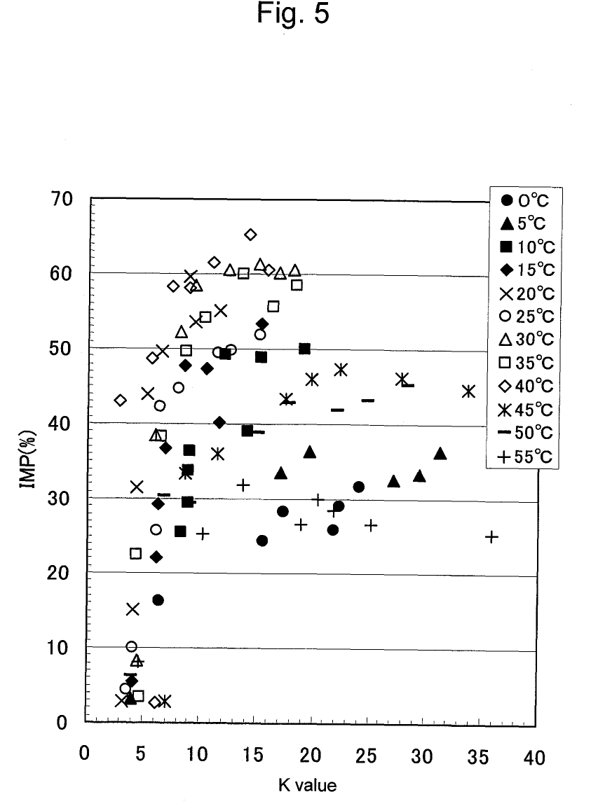

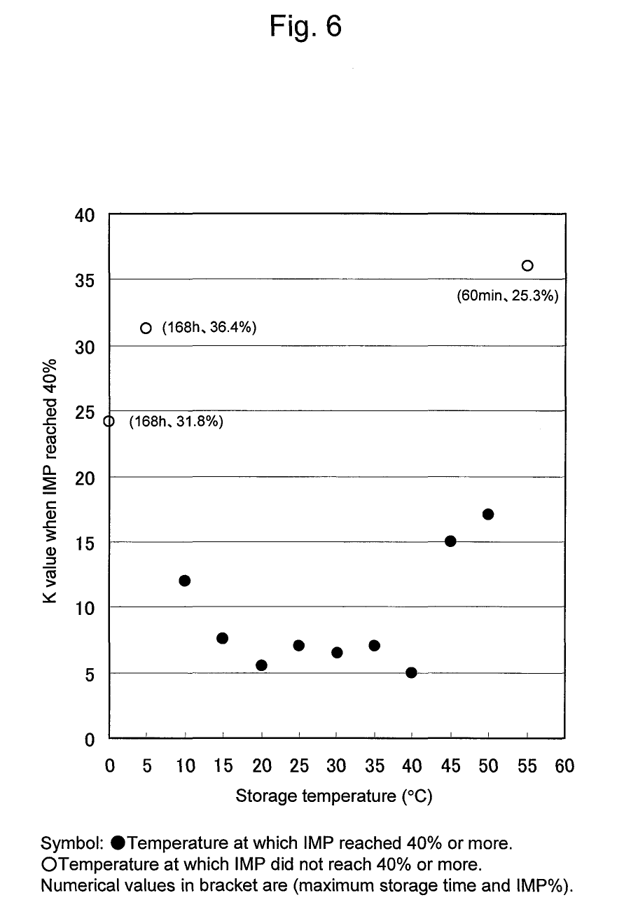

The data of Example 8 was added with data of storage at the temperatures of 5° C., 10° C., 15° C., 20° C., 30° C., 35° C., 40° C., 45° C. and 50° C., and the relationship diagram between the increases in IMP (%) that occurred during the storage and the increases in the K value involved therein was shown in FIG. 5. In this result, at 20° C. to 40° C., the K value was within a range of 0% to 15% and IMP (%) hit the maximum of slightly over 60%. The maximum value of IMP (%) was lowered as the temperature moved away higher or lower from that range. Moreover, from the result of FIG. 5, the K value at the time point when IMP had reached 40% was read, and its relationship with the storage temperature was shown in FIG. 6, where the temperatures at which IMP did not reach 40% were shown with ◯, and the maximum storage time and the K value at that time point were noted inside the round brackets next to each symbol. According to this result, the temperatures at which IMP did not reach 40% were 0° C., 5° C. and 55° C. Within the temperature range of 10° C. to 50° C. where IMP (%) reached 40%, a U-letter shaped dependence with respect to temperature was shown. That is to say, in the case of vannamei shrimp, within the temperature range of 15° C. to 40° C., IMP reached 40% with a low K value (5% to 10%). However, when the temperature moved away higher or lower from that temperature range, the K value increased, and when the temperature deviated even further, the K value alone increased while IMP was not likely to increase for that amount.

### Example 10

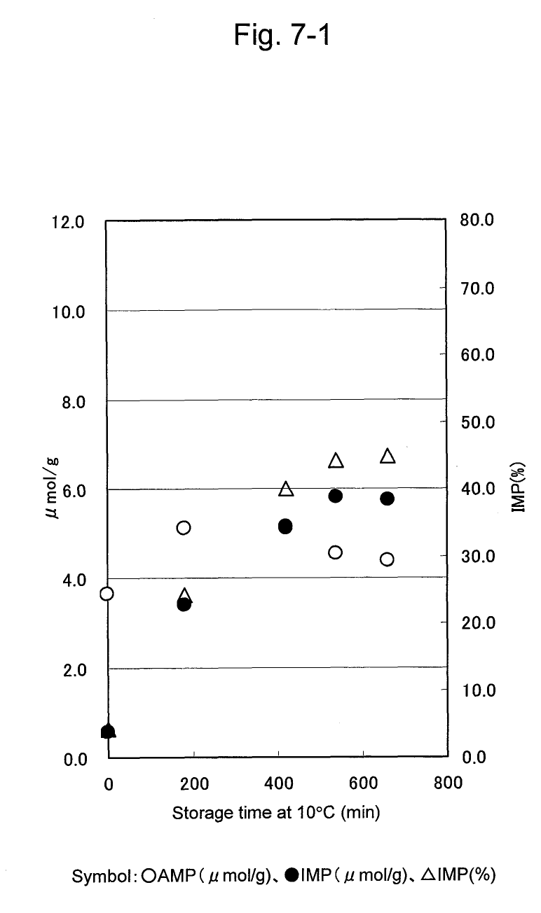

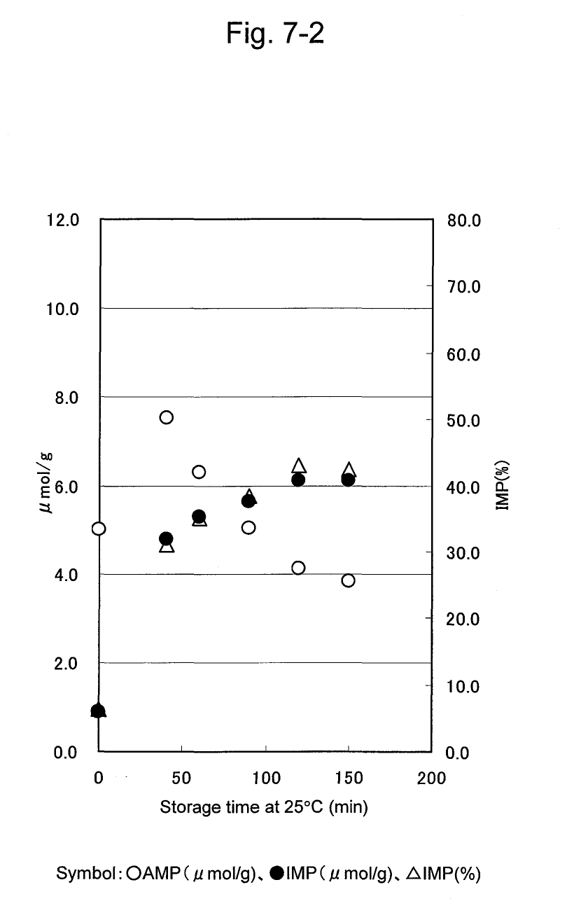

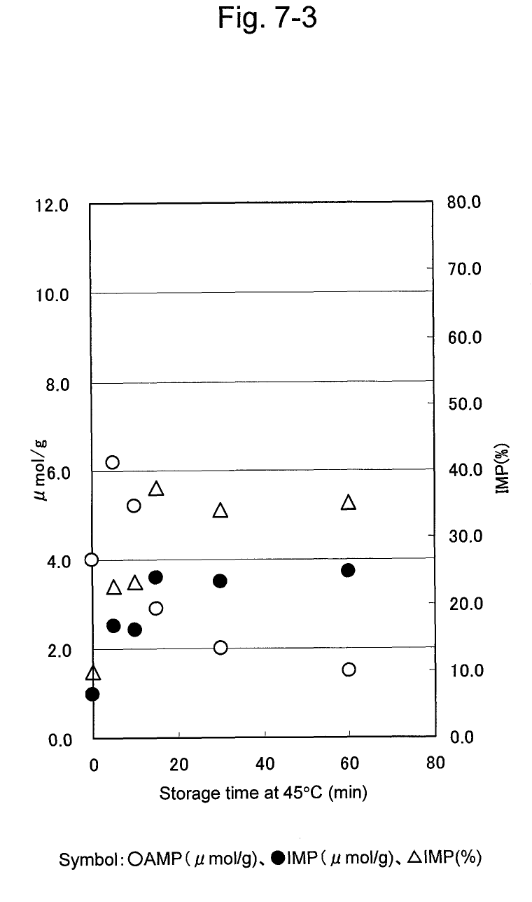

Frozen products of headless shell-on farmed kuruma shrimp (size 31/41 shrimp) that had been IQF frozen were subjected to a defrosting treatment in running water at 20° C. for 20 minutes, which were drained and then stored for a predetermined time at 10° C., 25° C., and 45° C., to track the changes of nucleic acid components over time. The results are shown in FIG. 7-1 to FIG. 7-3. At any of these temperatures, AMP (◯) once hit the maximum value at the beginning of the storage. This is because that the shrimp immediately after the defrosting which were prepared for the present experiment contained a large amount of ATP, and the ATP rapidly decomposed at the beginning of the storage to cause a temporary accumulation of AMP in the initial stage of storage. Subsequently, the AMP decreased over time. On the other hand, IMP () increased over time from the start of the storage, and its absolute concentrations and ratios increased to the same level in the storage at 10° C. and 25° C., although, compared to this, the increase in IMP was low at 45° C.

From the above results, as an effective treatment method for efficiently accumulating IMP in frozen shrimp, it has been understood that adjustment of the storage temperature after defrosting causes an efficient decomposition reaction from AMP to IMP, resulting in the accumulation of a high concentration of IMP. Moreover, although there is an approximately 5° C. variation depending on the type of shrimp, the optimum temperature range thereof is 10° C. to 50° C., and within the range, temperatures at which a high concentration of IMP can be further accumulated were 15° C. to 40° C. In other words, it has been understood that, with storage at temperatures above or below the temperature range, the increase in the K value involved in the increase in the accumulation amount of IMP occurs more largely, and thus IMP is unlikely to be efficiently accumulated and the maximum accumulation amount is decreased.

### Example 11

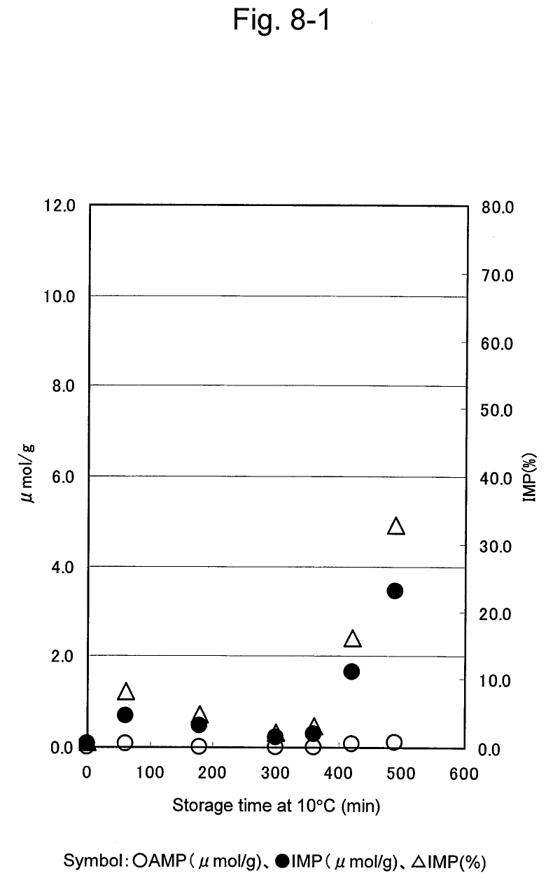

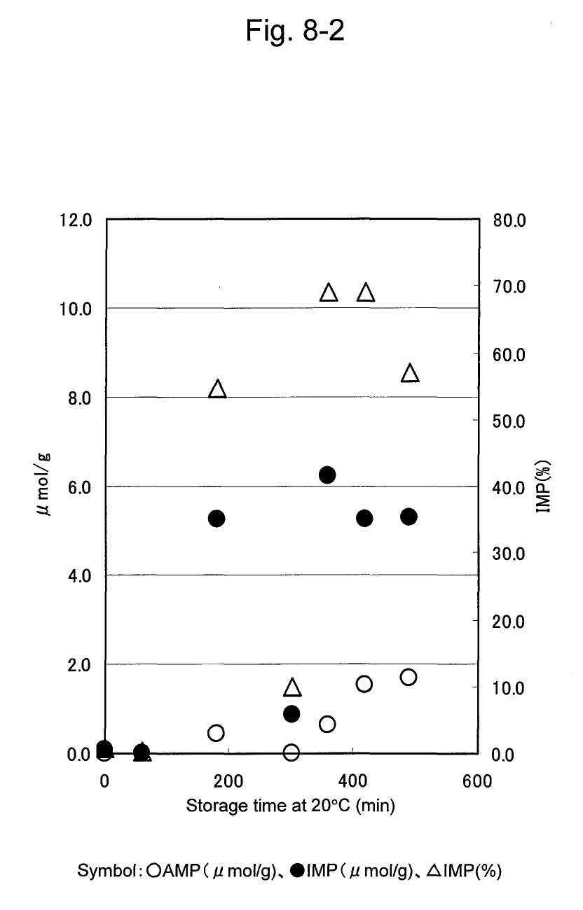

Live kuruma shrimp were killed on ice for an hour, then the heads and back veins were removed to prepare headless shell-on shrimp. They were stored at 10° C. and at 20° C. to track changes in nucleic acid components over time. The results are shown in FIG. 8-1 and FIG. 8-2. With storage at 10° C., AMP (◯) was hardly produced at all, although IMP () was accumulated belatedly after 400 minutes (about 6.5 hours) of storage. This is because that immediately after the live kuruma shrimp were killed on ice, ATP was predominant in the nucleic acid compositions and this state was maintained until 400 minutes of storage had elapsed, then ATP rapidly decreased and IMP started accumulating involved therein. On the other hand, in the case of storage at 20° C. also, ATP was predominant at the time point of the start of storage. However, IMP started accumulating after a shorter storage time than that of storage at 10° C., and IMP (%) accumulation hit the maximum of slightly under 70% occurred.

### Example 12

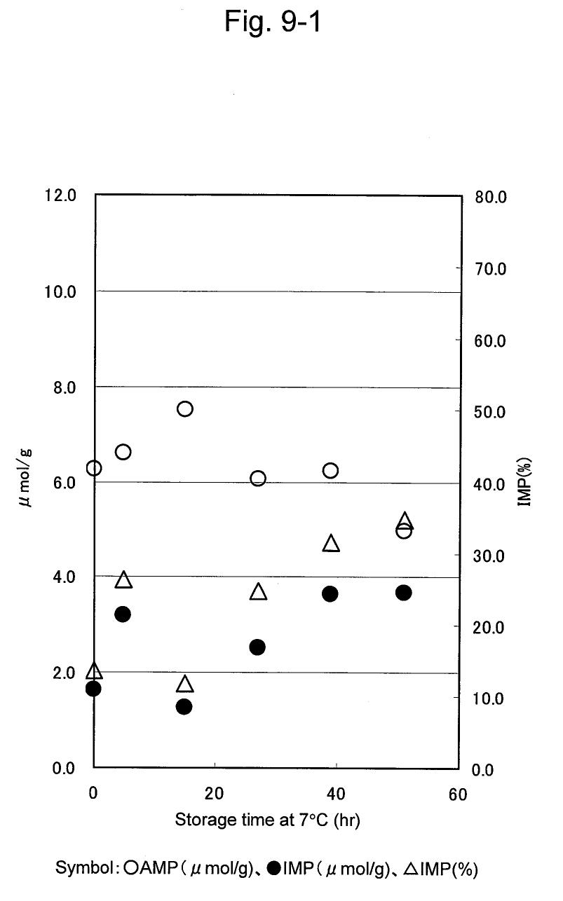

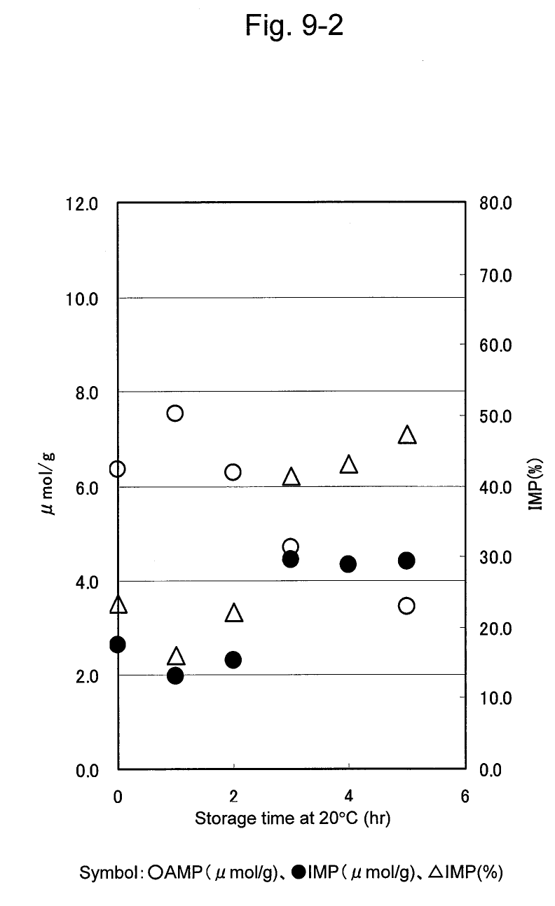

Black tiger shrimp were harvested from the pond, then killed on ice, then left for 3 to 5 hours, from which the heads and back veins were removed to prepare headless shell-on shrimp. They were stored at 7° C. and at 20° C. to track changes in nucleic acid components over time. The results are shown in FIG. 9-1 and FIG. 9-2.

At any of these temperatures, AMP increased once at the beginning of the storage and then IMP () accumulated involved in the decrease of AMP (◯). However, having a look at the maximum values, the absolute concentration and composition ratio of IMP were higher at 20° C. than those at 7° C.

### Example 13

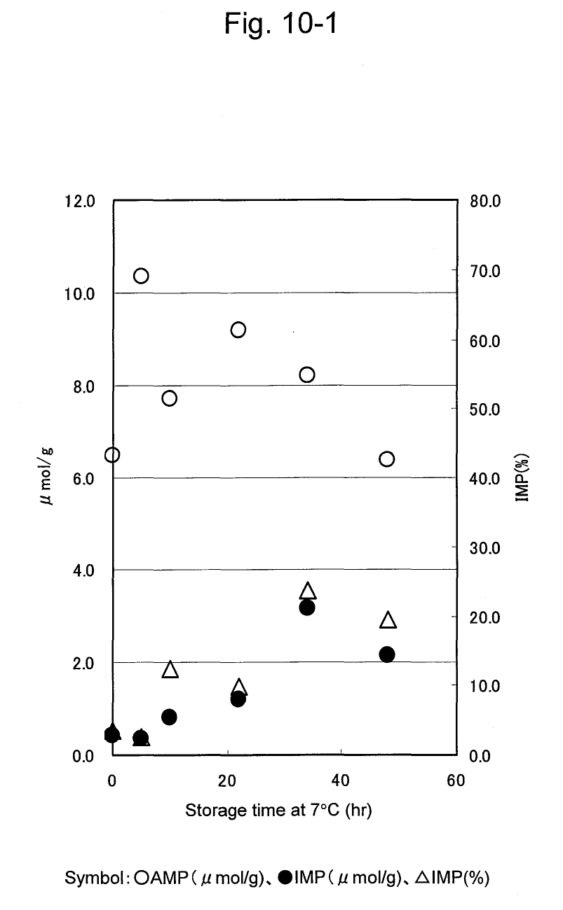

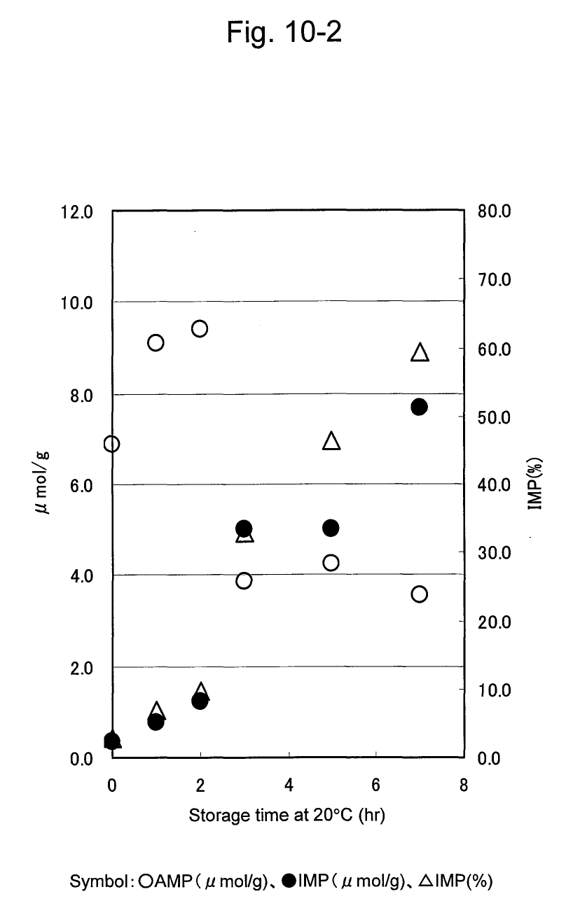

Vannamei shrimp were harvested from the pond, then killed on ice, and left for 3 to 5 hours, from which the heads and back veins were removed to prepare headless shell-on shrimp. They were stored at 7° C. and at 20° C. to track changes in nucleic acid components over time. The results are shown in FIG. 10-1 and FIG. 10-2. At any of these temperatures, AMP (◯) increased once at the beginning of the storage, and then IMP () accumulated involved in the decrease of AMP. However, having a look at the maximum values, the absolute concentration and composition ratio of IMP were higher at 20° C. than those at 7° C.

From the above results, even in cases of various types of unfrozen shrimps, accumulation of a high concentration of IMP was also confirmed at the optimum storage temperatures that had been investigated with frozen shrimp.

All publications, patents, and patent applications cited herein are incorporated herein by reference in their entirety.

1. A shrimp having enriched umami (delicious taste), in which a ratio of 5′-inosinic acid (IMP) in nucleic acid-relating substances is 40% or more.

2. The shrimp according to claim 1, wherein a K value is 20% or less.

3. The shrimp according to claim 1 or 2, wherein an absolute concentration of IMP is 3 μmol/g or more.

4. A fresh product, a frozen product, or a cooked product that uses the shrimp according to any one of claims 1 to 3.

5. The shrimp according to any one of claims 1 to 4, wherein the shrimp belongs to the genus Penaeus.

6. The shrimp according to claim 5, wherein the shrimp belonging to the genus Penaeus is any one of black tiger shrimp (Penaeus monodon), kuruma shrimp (Penaeus japonicus), fleshy shrimp (Penaeus chinensis), and vannamei shrimp (Penaeus vannamei).

7. A method of producing a shrimp, wherein the shrimp according to any one of claims 1 to 4 is maintained at a temperature of 10° C. to 50° C. for 0.1 to 24 hours to thereby accumulate IMP in the body of the shrimp.

8. The method of producing a shrimp according to claim 7, wherein the shrimp is maintained at a temperature of 15° C. to 40° C. for 0.1 to 10 hours to thereby accumulate IMP in the body of the shrimp.

9. The method of producing a shrimp according to claim 7 or 8, wherein a K value of the shrimp is suppressed to 20% or lower.

10. A method of accumulating IMP in the body of a shrimp, wherein the shrimp is maintained at a temperature of 10° C. to 50° C. for 0.1 to 24 hours, in which an AMP→IMP reaction is promoted and an IMP→HxR reaction is suppressed in the reaction of nucleic acid-relating substances expressed by ATP→ADP→AMP→IMP→HxR→Hx that posthumously occurs in the body of the shrimp.

11. The method according to claim 10, wherein the shrimps is maintained at a temperature of 15° C. to 40° C. for 0.1 to 10 hours.

12. A shrimps produced by the method according to claim 10 or 11.
